(19) United States
(12) Patent Application Publication
(10) Pub. No.: US 2010/0148843 A1
(43) Pub. Date: Jun. 17, 2010

(54) BOW TIE CLOCK DISTRIBUTION

(75) Inventor: Robert P. Masleid, Monte Sereno, CA (US)

Correspondence Address: OSHA LIANG LLP/Oracle, TWO HOUSTON CENTER, 909 FANNIN, SUITE 3500, HOUSTON, TX, 77010, US

(73) Assignee: Sun Microsystems, Inc., Santa Clara, CA (US)

(21) Appl. No.: 12/336,380

(22) Filed: Dec. 16, 2008

(51) Int. Cl. G06F 1/04

(52) U.S. Cl. 327/297

(57) ABSTRACT

A clock distribution network includes: a primary clock signal and a distribution tree coupled to the primary clock signal. The distribution tree derives a plurality of separate clock signals from the primary clock signal and provides each of the plurality of separate clock signals to each of a plurality of loads. The distribution tree comprises a plurality of bow tie elements.

### BACKGROUND OF INVENTION

FIG. 1 shows a conventional system 100 that includes one or more semiconductor device(s) 110. Each semiconductor device 110 includes one or more semiconductor die 120 encapsulated in a mechanical package 130. The mechanical package 130 serves as an electrical and mechanical interface between the die 120 and the system 100.

The system 100 provides one or more external clock signals to the semiconductor device 120. The mechanical package 130 provides the external clock signal(s) to the die 120. The die 120 generates one or more internal clock signals that are a function of the provided external clock signal(s). The internal clock signals are typically the most heavily loaded, the most widely distributed, and the fastest signals within the die 120. As such, clock distribution networks are used to provide the clock signals to the proper loads within the die.

FIG. 2 shows a conventional H-tree clock distribution network 200 as part of the semiconductor die 120. The H-tree clock distribution network 200 distributes an externally provided clock, received from a primary input 210, to a number of devices or loads 220 through the use of wires 230. The H-tree clock distribution network 200 uses a fractal pattern of H-elements 240 placed in hierarchical succession to form various levels of the clock distribution network.

Minimizing the delay through the clock distribution network reduces the distribution's exposure to error. Thus, it is desirable to minimize the skew between the numerous branches of the clock distribution network. However, modern semiconductor processes provide poor matching between individual devices and wires. In addition, wire propagation delay accounts for roughly half of the total clock distribution delay.

### SUMMARY OF INVENTION

According to one aspect of one or more embodiments of the present invention, a clock distribution network includes: a primary clock signal; and a distribution tree coupled to the primary clock signal. The distribution tree derives a plurality of separate clock signals from the primary clock signal, the distribution tree provides each of the plurality of separate clock signals to each of a plurality of loads, and the distribution tree comprises a plurality of bow tie elements.

According to one aspect of one or more embodiments of the present invention, a system includes: a semiconductor device; and a clock distribution network that distributes a primary clock within the semiconductor device. The clock distribution network includes the primary clock signal and a distribution tree coupled to the primary clock signal. The distribution tree derives a plurality of separate clock signals from the primary clock signal, the distribution tree provides each of the plurality of separate clock signals to each of a plurality of loads, and the distribution tree comprises a plurality of bow tie elements.

According to one aspect of one or more embodiments of the present invention, a method of minimizing clock skew in a semiconductor device includes: receiving a primary clock signal; and providing a distribution tree coupled to the primary clock signal. The distribution tree derives a plurality of separate clock signals from the primary clock signal, the distribution tree provides each of the plurality of separate clock signals to each of a plurality of loads, and the distribution tree comprises a plurality of bow tie elements.

Other aspects of the present invention will be apparent from the following description and the appended claims.

### BRIEF DESCRIPTION OF DRAWINGS

FIG. 1 shows a conventional system that includes one or more semiconductor device(s), each semiconductor device includes one or more semiconductor die.

FIG. 2 shows a conventional H-tree clock distribution network of a semiconductor die.

FIG. 3 shows bow tie elements, half-bow tie elements, extended half-bow tie elements, and three-half-bow tie elements in accordance with one or more embodiments of the present invention.

FIG. 4 shows a clock distribution network comprised of an ideal fractal clock tree of bow tie elements in accordance with one or more embodiments of the present invention.

FIG. 5 shows a clock distribution network comprised of a truncated fractal clock tree of bow tie elements in accordance with one or more embodiments of the present invention.

FIG. 6 shows a clock distribution network comprised of a “pure river” fractal clock tree of bow tie elements and extended half-bow tie elements in accordance with one or more embodiments of the present invention.

FIG. 7 shows a clock distribution network comprised of a rotated fractal clock tree of bow tie elements and half-bow tie elements in accordance with one or more embodiments of the present invention.

FIG. 8 shows a clock distribution network comprised of a rotated fractal clock tree of bow tie elements, half-bow tie elements, and three-half-bow tie elements with minimum crossings in accordance with one or more embodiments of the present invention.

FIG. 9 shows a clock distribution network comprised of a rotated fractal clock tree of bow tie elements, half-bow tie elements, three-half-bow tie elements, and hyper-fine bow tie elements with minimum crossings and hyper-fine Y-axis pitch in accordance with one or more embodiments of the present invention.

FIG. 10 shows a method of minimizing clock skew in a semiconductor device in accordance with one or more embodiments of the present invention.

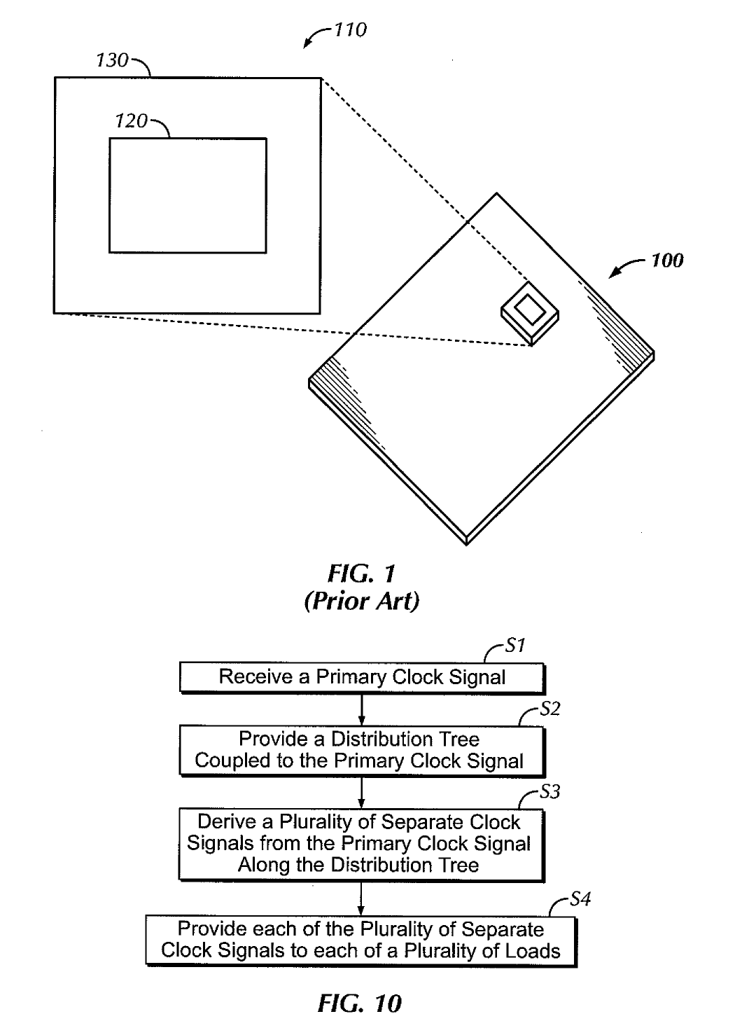

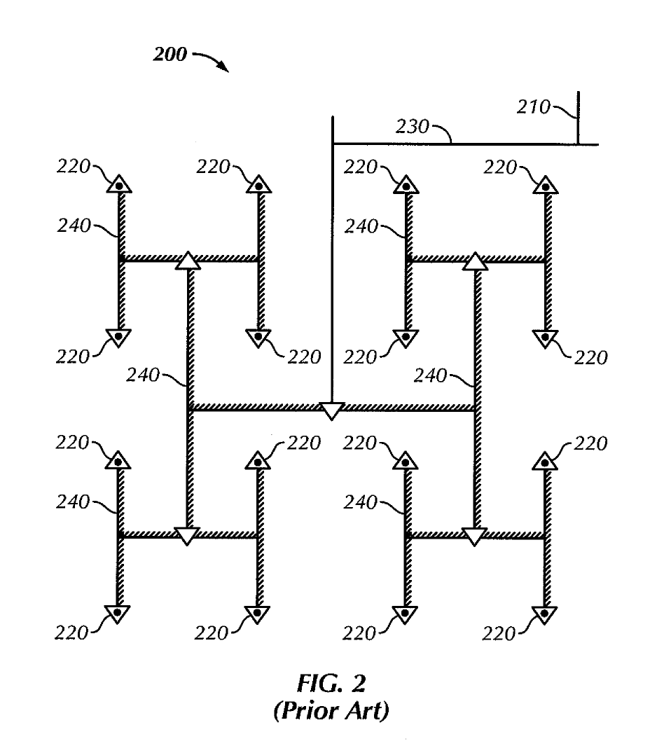

### DETAILED DESCRIPTION

Specific embodiments of the present invention will now be described in detail with reference to the accompanying figures. Like elements in the various figures are denoted by like reference numerals for consistency. Further, in the following detailed description of embodiments of the present invention, numerous specific details are set forth in order to provide a more thorough understanding of the present invention. In other instances, well-known features have not been described in detail to avoid obscuring the description of embodiments of the present invention.

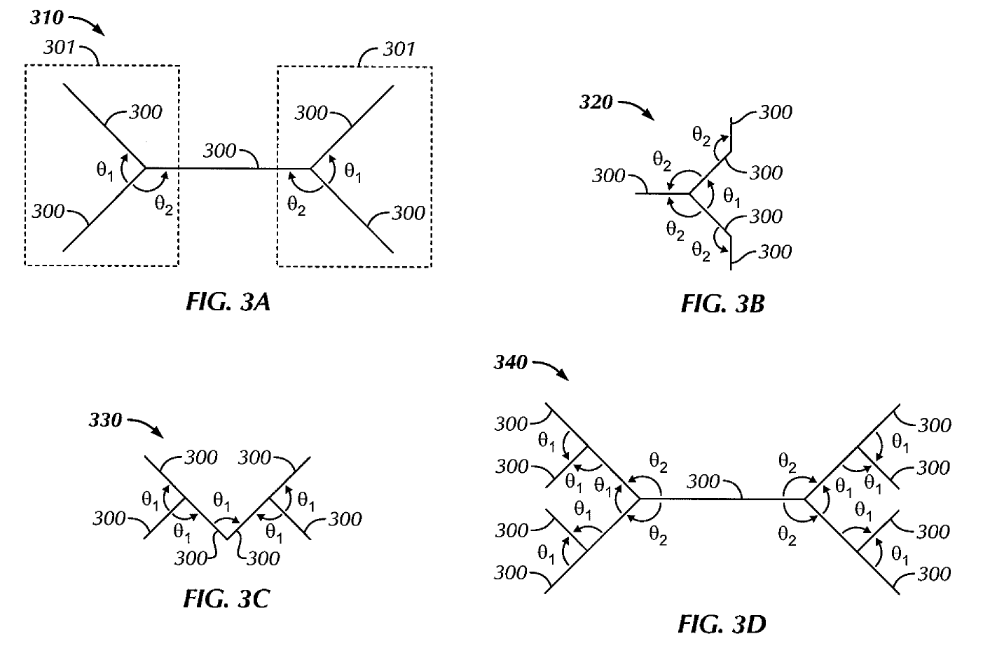

FIG. 3 shows a bow tie element in accordance with one or more embodiments of the present invention. With reference to FIG. 3(a), bow tie element 310 is comprised of two half-bow tie elements 301 and additional wire 300 structured at planar angles θ₁ and θ₂ as depicted in the figure. Each half-bow tie element 301 is comprised of two wires 300 structured such that the planar angle between the constituent wires 300 of the half bow tie 301 is θₜ. In one embodiment of the present invention, θ₁ is 90 degrees and θ₂ is 135 degrees. One of ordinary skill in the art will recognize that θ₁, θ₂, and the relative lengths of the various segments of wire 300 could be vary, separately or in combination, in accordance with one or more embodiments of the present invention. Additionally, one of ordinary skill in the art will recognize that bow tie element 310 or any constituent portion thereof could be rotated in accordance with one or more embodiments of the present invention.

With reference to FIG. 3(b), an extended half-bow tie element 320 is comprised of a half bow tie element 301 and three additional wires 300 structured at planar angles θ₁ and θ₂ as depicted in the figure. In one embodiment of the present invention, θ₁ is 90 degrees and θ₂ is 135 degrees. One of ordinary skill in the art will recognize that θ₁, θ₂, and the relative lengths of the various segments of wire 300 could vary, separately or in combination, in accordance with one or more embodiments of the present invention. Additionally, one of ordinary skill in the art will recognize that extended half-bow tie element 320 could be rotated in accordance with one or more embodiments of the present invention.

With reference to FIG. 3(c), a three-half-bow tie element 330 is comprised of three half-bow tie elements 301. Each half-bow tie element 301 is comprised of two wires 300 structured such that the planar angle between the constituent wires 300 of the half-bow tie 301 is θₜ. The three-half-bow tie element 330 is comprised of three separate half-bow tie elements 301 structured at planar angle θ₁ as depicted in the figure. In one embodiment of the present invention, θ₁ is 90 degrees. One of ordinary skill in the art will recognize that θ₁ and the relative lengths of the various segments of wire 300 could vary, separately or in combination, in accordance with one or more embodiments of the present invention. Additionally, one of ordinary skill in the art will recognize that three-half-bow tie element 330 could be rotated in accordance with one or more embodiments of the present invention.

With reference to FIG. 3(d), a hyper-fine bow tie element 340 is comprised of two half-bow tie elements 301 and five additional wires 300 structured at angles θ₁ and θ₂ as depicted in the figure. In one embodiment of the present invention, θ₁ is 90 degrees and θ₂ is 135 degrees. One of ordinary skill in the art will recognize that θ₁, θ₂, and the relative lengths of the various segments of wire 300 could vary in accordance with one or more embodiments of the present invention. Additionally, one of ordinary skill in the art will recognize that hyper-fine bow tie element 340 could be rotated in accordance with one or more embodiments of the present invention.

In view of the above, one of ordinary skill in the art will recognize that there are a variety of ways in which to construct a bow tie element in accordance with one or more embodiments of the present invention.

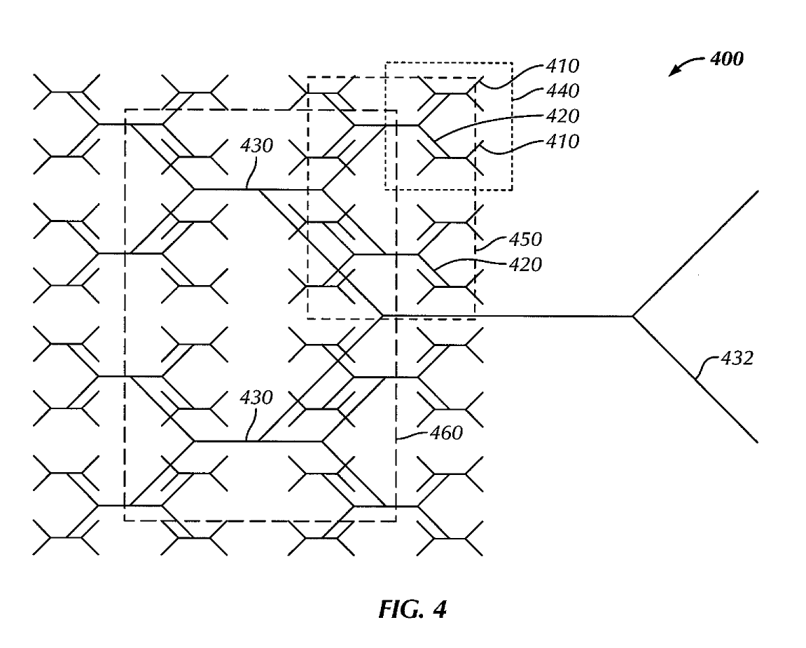

FIG. 4 shows a clock distribution network comprised of an ideal fractal clock tree of bow tie elements in accordance with one or more embodiments of the present invention. One of ordinary skill in the art will recognize that fractals are hierarchical patterns comprised of unit tiles. The unit tiles are comprised of one or more elements. The elements at each level of the hierarchy are similar, but scaled based on the position of the elements within the hierarchy (self-similarity).

In one or more embodiments of the present invention, the clock distribution network is comprised of fractal clock tree 400. Fractal clock tree 400 is comprised of a plurality of bow tie elements 410, 420, 430, and 432 that are each utilized at their respective hierarchical level of the fractal clock tree 400. At the lowest hierarchical level, unit tile 440 is comprised of two bow tie elements 410. At the next hierarchical level, unit tile 450 is comprised of two bow tie elements 420. At the highest hierarchical level, unit tile 460 is comprised of two bow tie elements 430. One of ordinary skill in the art will recognize that additional bow tie elements of a different scale and additional hierarchical levels could be utilized in accordance with one or more embodiments of the present invention.

The clock distribution network minimizes the maximum distance from source to destination because each bow tie element 410, 420, 430, and 432 utilizes diagonal routes. In one embodiment of the present invention, bow tie elements 410, 420, 430, and 432 provide for diagonal routes that are approximately 30% shorter than the typical Manhattan-routed H-tree distribution. In addition, because of the reduced distance, approximately 30% fewer repeaters are required for the clock distribution network.

Moreover, modern semiconductor processes recommend or require uniform poly-silicon orientation. This in turn produces uniform circuit stack orientation and uniform clock spine orientation. Clock spines are required to be spatially frequent and low skew. As a result, the clock distribution destination grid need not have equal X-axis and Y-axis pitch. In one embodiment of the present invention, the use of bow tie elements allows for non-uniform X-axis and Y-axis pitches. The use of bow tie elements in a clock tree provides fine pitch to match the clock spine pitch in the Y-axis direction and allows for coarse pitch in the X-axis direction, which is desirable because the clock spines themselves must provide a low skew distribution of the clock in the X-axis direction. The bow tie element structure exploits the coarse pitch in the X-axis direction to reduce the total routing length of the clock distribution network and the number of clock self-crossings.

In one or more embodiments of the present invention, the clock distribution network of FIG. 4 provides for minimal delay through the clock tree and minimal power for the clock tree as measured by the total amount of power and number of repeaters used. In one embodiment of the present invention, as depicted in FIG. 4, the clock distribution network has numerous self-crossings.

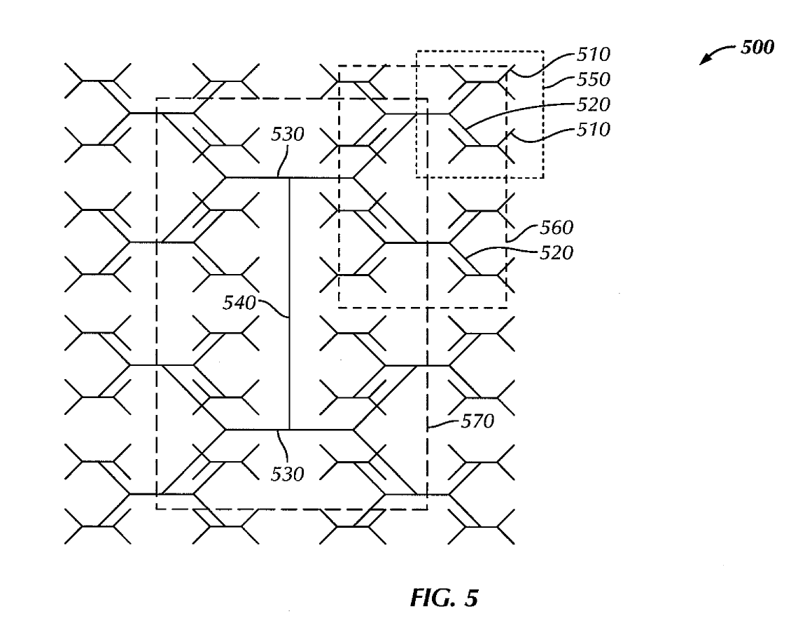

FIG. 5 shows a clock distribution network comprised of a truncated fractal clock tree of bow tie elements in accordance with one or more embodiments of the present invention. In one or more embodiments of the present invention, the clock distribution network is comprised of fractal clock tree 500. Fractal clock tree 500 is comprised of a plurality of bow tie elements 510, 520, 530, and additional wire 540. Bow tie elements 510, 520, 530, and wire 540 are each utilized at their respective hierarchical level of the fractal 500. At the lowest hierarchical level, unit tile 550 is comprised of two bow tie elements 510. At the next hierarchical level, unit tile 560 is comprised of two bow tie elements 520. At the highest hierarchical level, unit tile 570 is comprised of two bow tie elements 530 and wire 540. One of ordinary skill in the art will recognize that additional bow tie elements and wires of a different scale and additional hierarchical levels could be utilized in accordance with one or more embodiments of the present invention. In one embodiment of the present invention, as depicted in FIG. 5, the clock distribution network provides four self-crossings.

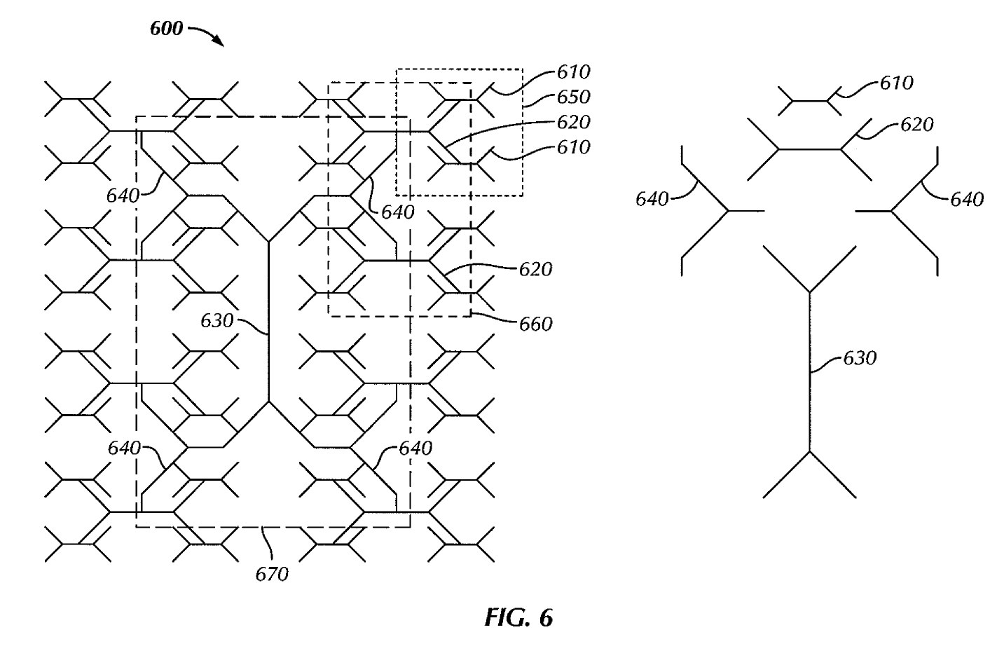

FIG. 6 shows a clock distribution network comprised of a “pure river” fractal clock tree of bow tie elements and extended half-bow tie elements in accordance with one or more embodiments of the present invention. In one or more embodiments of the present invention, the clock distribution network is comprised of fractal clock tree 600. Fractal clock tree 600 is comprised of a plurality of bow tie elements 610, 620, 630, and extended half-bow tie element 640. Bow tie elements 610, 620, 630, and extended half-bow tie element 640 are each utilized at their respective hierarchical level of the fractal 600. At the lowest hierarchical level, unit tile 650 is comprised of two bow tie elements 610. At the next hierarchical level, unit tile 660 is comprised of two bow tie elements 620. At the highest hierarchical level, unit tile 670 is comprised of rotated bow tie element 630 and four extended half-bow tie elements 640. One of ordinary skill in the art will recognize that additional bow tie elements, extended half-bow tie elements, and wires of a different scale and additional hierarchical levels could be utilized in accordance with one or more embodiments of the present invention. In one embodiment of the present invention, as depicted in FIG. 6, the clock distribution network provides for a “pure river” route with no self-crossings.

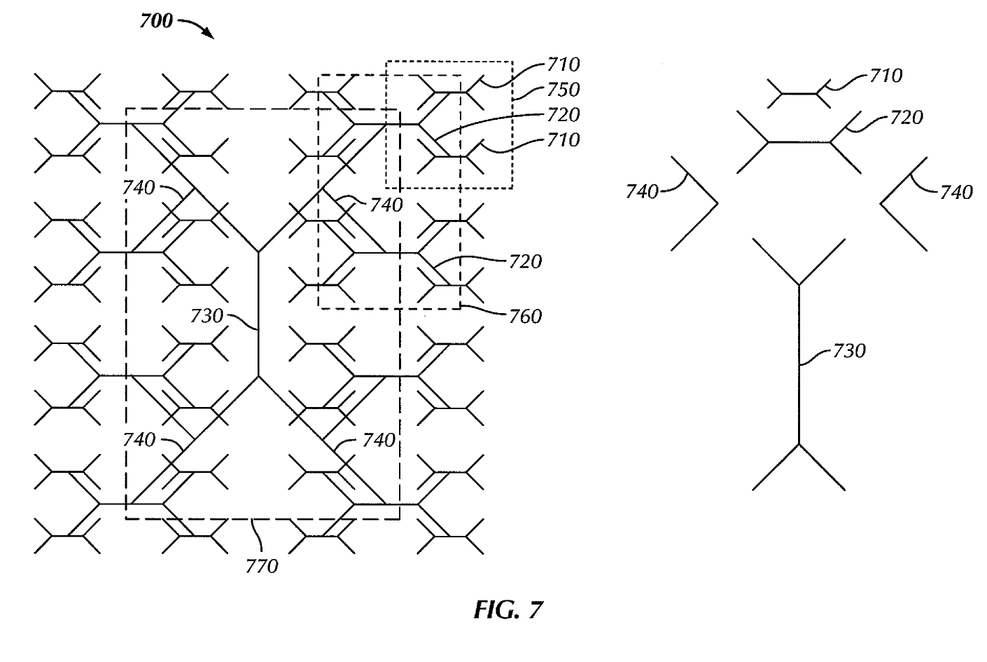

FIG. 7 shows a clock distribution network comprised of a rotated fractal clock tree of bow tie elements and half-bow tie elements in accordance with one or more embodiments of the present invention. In one or more embodiments of the present invention, the clock distribution network is comprised of fractal clock tree 700. Fractal clock tree 700 is comprised of a plurality of bow tie elements 710, 720, 730, and half-bow tie elements 740. Bow tie elements 710, 720, 730, and half-bow tie elements 740 are each utilized at their respective hierarchical level of the fractal clock tree 700. At the lowest hierarchical level, unit tile 750 is comprised of two bow tie elements 710. At the next hierarchical level, unit tile 760 is comprised of two bow tie elements 720. At the highest hierarchical level, unit tile 770 is comprised of rotated bow tie element 730 and four half-bow tie elements 740. One of ordinary skill in the art will recognize that additional bow tie elements, half-bow tie elements, and wires of a different scale and additional hierarchical levels could be utilized in accordance with one or more embodiments of the present invention. In one embodiment of the present invention, as depicted in FIG. 7, the clock distribution network provides twelve self-crossings.

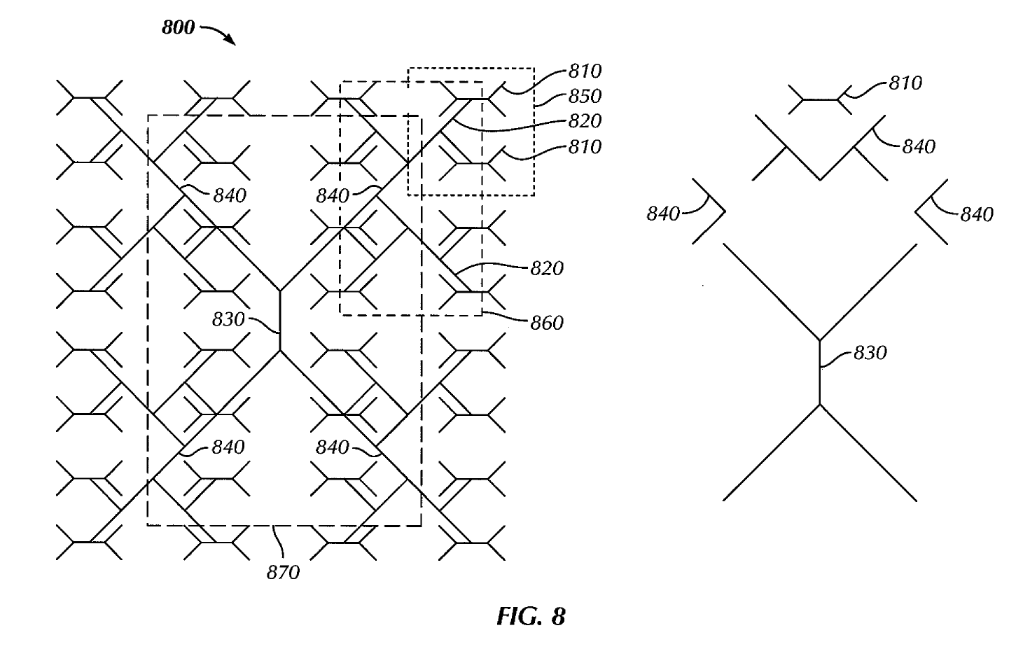

FIG. 8 shows a clock distribution network comprised of a rotated fractal clock tree of bow tie elements, half-bow tie elements, and three-half-bow tie elements with minimum crossings in accordance with one or more embodiments of the present invention. In one or more, embodiments of the present invention, the clock distribution network is comprised of fractal clock tree 800. Fractal clock tree 800 is comprised of a plurality of bow tie elements 810, 830, half-bow tie elements 840, and three-half bow tie elements 820. Bow tie elements 810, 830, half-bow tie elements 840, and three-half bow tie elements 820 are each utilized at their respective hierarchical level of the fractal clock tree 800. At the lowest hierarchical level, unit tile 850 is comprised of two bow tie elements 810. At the next hierarchical level, unit tile 860 is comprised of two three-half-bow tie elements 820. At the highest hierarchical level, unit tile 870 is comprised of rotated bow tie element 830 and four half-bow tie elements 840. One of ordinary skill in the art will recognize that additional bow tie elements, half-bow tie elements, three-half-bow tie elements, and wires of a different scale and additional hierarchical levels could be utilized in accordance with one or more embodiments of the present invention. In one embodiment of the present invention, as depicted in FIG. 8, the clock distribution network provides four self-crossings.

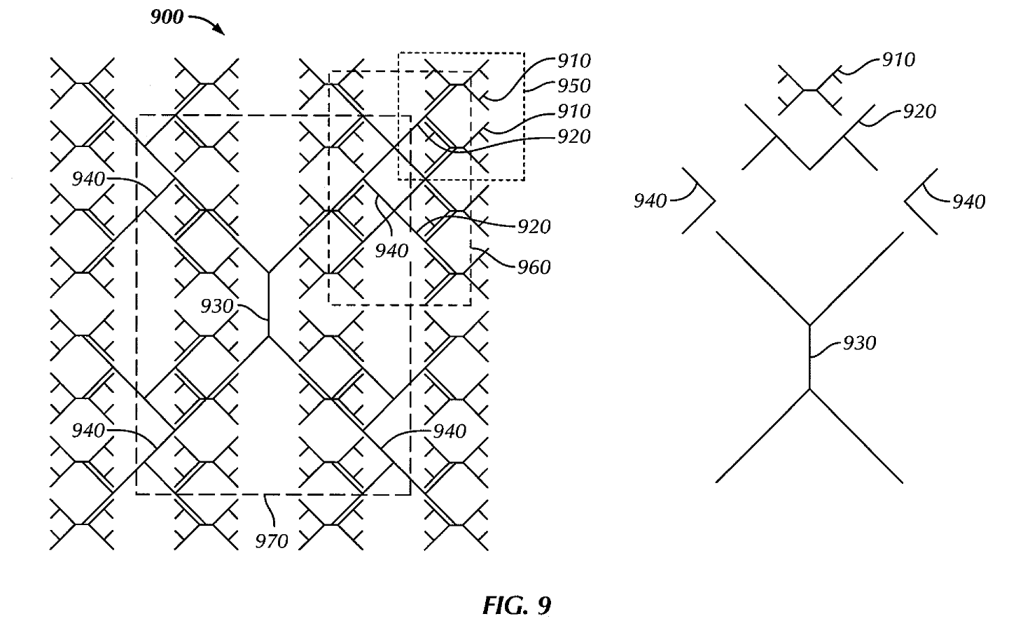

FIG. 9 shows a clock distribution network comprised of a rotated fractal clock tree of bow tie elements, half-bow tie elements, three-half-bow tie elements, and hyper-fine bow tie elements with minimum crossings and hyper-fine Y-axis pitch in accordance with one or more embodiments of the present invention. In one or more embodiments of the present invention, the clock distribution network is comprised of fractal clock tree 900. Fractal clock tree 900 is comprised of a plurality of bow tie elements 930, half-bow tie elements 940, three-half-bow tie elements 920, and hyper-fine bow tie elements 910. Bow tie elements 930, half-bow tie elements 940, three-half-bow tie elements 920, and hyper-fine bow tie elements 910 are each utilized at their respective hierarchical level of the fractal 900. At the lowest hierarchical level, unit tile 950 is comprised of two hyper-fine bow tie elements 910. At the next hierarchical level, unit tile 960 is comprised of two three-half-bow tie elements 920. At the highest hierarchical level, unit tile 970 is comprised of rotated bow tie element 930 and four half-bow tie elements 940. One of ordinary skill in the art will recognize that additional bow tie elements, half-bow tie elements, three-half bow tie elements, hyper-fine bow tie elements, and wires of a different scale and additional hierarchical levels could be utilized in accordance with one or more embodiments of the present invention.

In one embodiment of the present invention, as depicted in FIG. 9, the clock distribution network provides for minimum crossings and hyper-fine Y-axis pitch.

FIG. 10 shows a method of minimizing clock skew in a semiconductor device in accordance with one or more embodiments of the present invention. In S1, the semiconductor device receives a primary clock signal. In S2, the semiconductor device provides a distribution tree that is coupled to the primary clock signal. In S3, the distribution tree derives a plurality of separate clock signals from the primary clock signal along the clock distribution tree. In S4, the distribution tree provides each of the plurality of separate clock signals to each of a plurality of loads. The distribution tree comprises a plurality of bow tie elements and may include one or more half-bow tie elements, three-half-bow tie elements, hyper-fine bow tie elements, and wires of varied length depending on the requirements of the application. One of ordinary skill in the art will recognize that the distribution tree may include one or more circuits as part of the deriving and providing of the plurality of separate clock signals.

Advantages of one or more embodiments of the present invention may include one or more of the following.

In one or more embodiments of the present invention, a bow tie clock distribution exploits uniform poly-silicon orientation and diagonal routing to distribute a primary clock signal to a semiconductor device with minimal wire delay and minimal total wire usage.

In one or more embodiments of the present invention, a bow tie clock distribution provides for minimal clock skew and minimal clock distribution power.

In one or more embodiments of the present invention, a bow tie clock distribution utilizes diagonal routes that are approximately 30% shorter than typical Manhattan-routed H-tree distributions. Because the routes are shorter, fewer repeaters are required, thereby reducing clock distribution power.

In one or more embodiments of the present invention, a bow tie clock distribution allows for non-uniform X-axis and Y-axis pitches. In one or more embodiments of the present invention, the use of bow tie elements provides for coarse pitch in the X-axis direction and fine pitch in the Y-axis direction. In one or more embodiments of the present invention, the use of bow-tie elements provides for fine pitch in the X-axis direction and coarse pitch in the Y-axis direction.

In one or more embodiments of the present invention, a bow tie clock distribution provides minimal skew in a “pure river” route.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A clock distribution network comprising:
a primary clock signal; and
a distribution tree coupled to the primary clock signal;
wherein the distribution tree derives a plurality of separate clock signals from the primary clock signal,
the distribution tree provides each of the plurality of separate clock signals to each of a plurality of loads, and
the distribution tree comprises a plurality of bow tie elements.

2. The clock distribution network of claim 1, the distribution tree further comprising at least one of a half-bow tie element, an extended half-bow tie element, a three-half-bow tie element, a hyper-fine bow tie element, an H-tree element, or additional wire.

3. The clock distribution network of claim 1, wherein the distribution tree provides for different X-axis and Y-axis pitches.

4. The clock distribution network of claim 1, wherein the distribution tree provides fine pitch in a Y-axis direction and coarse pitch in an X-axis direction.

5. The clock distribution network of claim 1, wherein the distribution tree uses uniform poly-silicon orientations.

6. The clock distribution network of claim 2, wherein the distribution tree uses diagonal routing.

7. A system comprising:
a semiconductor device; and
a clock distribution network that distributes a primary clock within the semiconductor device;
wherein the clock distribution network comprises:
the primary clock signal;
a distribution tree coupled to the primary clock signal;
wherein the distribution tree derives a plurality of separate clock signals from the primary clock signal,
the distribution tree provides each of the plurality of separate clock signals to each of a plurality of loads, and
the distribution tree comprises a plurality of bow tie elements.

8. The system of claim 7, the distribution tree further comprising at least one of a half-bow tie element, an extended half-bow tie element, a three-half-bow tie element, a hyper-fine bow tie element, an H-tree element, or additional wire.

9. The system of claim 7, wherein the distribution tree provides for different X-axis and Y-axis pitches.

10. The system of claim 7, wherein the distribution tree provides fine pitch in a Y-axis direction and coarse pitch in an X-axis direction.

11. The system of claim 7, wherein the distribution tree uses uniform poly-silicon orientations.

12. The system of claim 7, wherein the distribution tree uses diagonal routing.

13. A method of minimizing clock skew in a semiconductor device comprising:
receiving a primary clock signal; and
providing a distribution tree coupled to the primary clock signal;
wherein the distribution tree derives a plurality of separate clock signals from the primary clock signal,
the distribution tree provides each of the plurality of separate clock signals to each of a plurality of loads, and
the distribution tree comprises a plurality of bow tie elements.

14. The method of claim 13, the distribution tree further comprising a plurality of H-tree elements.

15. The method of claim 13, wherein the distribution tree provides for different X-axis and Y-axis pitches.

16. The method of claim 13, wherein the distribution tree provides fine pitch in a Y-axis direction and coarse pitch in an X-axis direction.

17. The method of claim 13, wherein the distribution tree uses uniform poly-silicon orientations.

18. The method of claim 13, wherein the distribution tree uses diagonal routing.
